(19) United States
(12) Patent Application Publication
(10) Pub. No.: US 2020/0364478 A1
(43) Pub. Date: Nov. 19, 2020

(54) METHOD AND APPARATUS FOR LIVENESS DETECTION, DEVICE, AND STORAGE MEDIUM

(71) Applicant: BEIJING SENSETIME TECHNOLOGY DEVELOPMENT CO., LTD., Beijing (CN)

(72) Inventors: Rui ZHANG, Beijing (CN); Mingchao Xu, Beijing (CN); Liwei Wu, Beijing (CN); Cheng Li, Beijing (CN)

(21) Appl. No.: 16/933,290

(22) Filed: Jul. 20, 2020

Related U.S. Application Data
(63) Continuation of application No. PCT/CN2019/114893, filed on Oct. 31, 2019.

(30) Foreign Application Priority Data
Mar. 29, 2019 (CN) 201910250962.5

(51) Int. Cl. G06K 9/00; G06N 3/04; G06N 3/08

(52) U.S. Cl. CPC G06K 9/00906; G06K 9/00288; G06N 3/08; G06N 3/0454; G06K 9/00268

(57) ABSTRACT

A method and apparatus for liveness detection, a device, and a storage medium are provided. The method for liveness detection includes: performing reconstruction processing based on an image to be detected including a target object to obtain a reconstructed image; obtaining a reconstruction error based on the reconstructed image; and obtaining a classification result of the target object based on the image to be detected and the reconstruction error, where the classification result is living or non-living.

### CROSS-REFERENCE TO RELATED APPLICATIONS

The present disclosure is a U.S. continuation application of International Application No. PCT/CN2019/114893, filed on Oct. 31, 2019, which claims priority to Chinese Patent Application No. 201910250962.5, filed to the China National Intellectual Property Administration on Mar. 29, 2019 and entitled “METHOD AND APPARATUS FOR LIVENESS DETECTION, DEVICE, AND STORAGE MEDIUM”. The contents of International Application No. PCT/CN2019/114893 and Chinese Patent Application No. 201910250962.5 are incorporated herein by reference in their entireties.

### BACKGROUND

With the continuous development of computer vision technology, face recognition technology has been widely applied, and face anti-spoofing detection is an indispensable part of face recognition. At present, a face recognition function has been used in many applications or systems in work and life, for example, opening an account, registering for a card, registering, and the like by means of identity authentication, and the face recognition function is generally required to have a face anti-spoofing function to prevent some lawbreakers from using spoofing face vulnerabilities to exchange or steal benefits. Especially in the Internet finance related industry, an imposter probably deceives the system by spoofing biological recognition information of a certain person so as to defraud money. The face anti-spoofing detection is applied to these scenarios.

In face anti-spoofing detection, due to the characteristics of easy acquisition and easy spoofing of faces, it is necessary to determine whether a face image in front of a camera comes from a real person by liveness detection, so as to improve the security of face recognition. At present, how to perform liveness detection for various possible characteristics of easy spoofing is a research hotspot in the art.

### SUMMARY

The present disclosure relates to image processing technologies, and in particular to a method and apparatus for liveness detection, a device, and a storage medium.

Embodiments of the present disclosure provide a technical solution for liveness detection and a technical solution for discriminative network training.

According to one aspect of the embodiments of the present disclosure, provided is a method for liveness detection, including: performing reconstruction processing based on an image to be detected including a target object to obtain a reconstructed image; obtaining a reconstruction error based on the reconstructed image; and obtaining a classification result of the target object based on the image to be detected and the reconstruction error, where the classification result is living or non-living.

According to another aspect of the embodiments of the present disclosure, provided is an apparatus for liveness detection, including: a reconstructing module, configured to perform reconstruction processing based on an image to be detected including a target object to obtain a reconstructed image; a first obtaining module, configured to obtain a reconstruction error based on the reconstructed image; and a second obtaining module, configured to obtain a classification result of the target object based on the image to be detected and the reconstruction error, where the classification result is living or non-living.

According to still another aspect of the embodiments of the present disclosure, provided is an electronic device, including: a memory, configured to store computer programs; and a processor, configured to execute the computer programs stored in the memory, where when the computer programs are executed, the method for liveness detection according to any one of the embodiments of the present disclosure is implemented.

According to yet another aspect of the embodiments of the present disclosure, provided is a computer readable storage medium having computer programs stored thereon, where when the computer programs are executed via a processor, the method for liveness detection according to any one of the embodiments of the present disclosure is implemented.

Based on the method and apparatus for liveness detection, device, and storage medium provided by the embodiments of the present disclosure, reconstruction processing is performed based on an image to be detected including a target object to obtain a reconstructed image, a reconstruction error is obtained based on the reconstructed image, and then a classification result that the target object is living or non-living is obtained based on the image to be detected and the reconstruction error, thereby effectively distinguishing whether the target object in the image to be detected is living or non-living, effectively defending against unknown types of spoofing attacks, and improving anti-spoofing performance.

Further optionally, in the method and apparatus for liveness detection, device, and storage medium provided by the embodiments of the present disclosure, a generative adversarial network is trained via the training set; after the training is completed, the generative adversarial network obtains a discriminative network for performing the method for liveness detection according to the foregoing embodiments; and by using a generative and adversarial mode of the generative adversarial network, the diversity of samples may be increased, the defense capability of the discriminative network against the unknown types of spoofing attacks may be improved, and the precision of defense against known spoofing attacks may be improved.

The technical solutions of the present disclosure are further described in detail below by the accompanying drawings and embodiments.

### BRIEF DESCRIPTION OF DRAWINGS

The accompanying drawings constituting a part of the specification describe the embodiments of the present disclosure, and are intended to explain the principles of the present disclosure together with the descriptions.

According to the following detailed descriptions, the present disclosure may be understood more clearly with reference to the accompanying drawings.

FIG. 1 is a flowchart of a method for liveness detection according to the embodiments of the present disclosure.

FIG. 2 is another flowchart of the method for liveness detection according to the embodiments of the present disclosure.

FIG. 3 is still another flowchart of the method for liveness detection according to the embodiments of the present disclosure.

FIG. 4A is a schematic structural diagram of a generative adversarial network in the embodiments of the present disclosure.

FIG. 4B is a flowchart of a method for discrimination processing provided by the embodiments of the present disclosure.

FIG. 4C is another flowchart of the method for discrimination processing provided by the embodiments of the present disclosure.

FIG. 5 is a flowchart of a method for training a discriminative network according to the embodiments of the present disclosure.

FIG. 6 is a flowchart of training a generative network in the embodiments of the present disclosure.

FIG. 7 is a flowchart of training a discriminative network in the embodiments of the present disclosure.

FIG. 8 is an application example diagram of an embodiment shown in FIG. 2 of the present disclosure.

FIG. 9 is a schematic structural diagram of an apparatus for liveness detection according to the embodiments of the present disclosure.

FIG. 10 is another schematic structural diagram of the apparatus for liveness detection according to the embodiments of the present disclosure.

FIG. 11 is a schematic structural diagram of an electronic device provided by the embodiments of the present disclosure.

### DETAILED DESCRIPTION

Various exemplary embodiments of the present disclosure are now described in detail with reference to the accompanying drawings. It should be noted that, unless otherwise stated specifically, relative arrangement of the components and steps, the numerical expressions, and the values set forth in the embodiments are not intended to limit the scope of the present disclosure.

A person skilled in the art may understand that the terms such as “first” and “second” in the embodiments of the present disclosure are only used for distinguishing different steps, devices or modules, etc., and do not indicate any specific technical meaning or an inevitable logical sequence therebetween.

It should also be understood that, in the embodiments of the present disclosure, “a plurality of” may refer to two or more, and “at least one” may refer to one, two, or more.

It should also be understood that any component, data, or structure mentioned in the embodiments of the present disclosure should be generally understood as one or more under the condition that there is no explicit definition or no opposite motivation is provided in the context.

In addition, the term “and/or” in the present disclosure is merely an association relationship describing associated objects, indicating that three relationships may exist, for example, A and/or B, which may indicate that A exists separately, both A and B exist, and B exists separately. In addition, the character “I” in the present disclosure generally indicates that the associated objects before and after the character “I” are in an “or” relationship.

It should also be understood that, the descriptions of the embodiments in the present invention focus on differences between the embodiments, and for same or similar parts in the embodiments, refer to these embodiments. For the sake of brevity, details are not described again.

At the same time, it should be understood that, for ease of description, the dimensions of various parts shown in the accompanying drawings are not drawn according to an actual proportional relationship.

The following descriptions of at least one exemplary embodiment are merely illustrative actually, and are not intended to limit the present disclosure and the applications or uses thereof.

Technologies, methods and devices known to a person of ordinary skill in the related art may not be discussed in detail, but such technologies, methods and devices should be considered as a part of the specification in appropriate situations.

It should be noted that similar reference numerals and letters in the following accompanying drawings indicate similar items. Therefore, once an item is defined in an accompanying drawing, the item does not need to be further discussed in the subsequent accompanying drawings.

The embodiments of the present disclosure may be applied to electronic devices such as terminal devices, computer systems, and servers, which may operate with numerous other general-purpose or special-purpose computing system environments or configurations. Examples of well-known terminal devices, computing systems, environments, and/or configurations suitable for use together with the electronic devices such as terminal devices, computer systems, and servers include, but are not limited to, personal computer systems, server computer systems, thin clients, thick clients, handheld or laptop devices, microprocessor-based systems, set top boxes, programmable consumer electronics, network personal computers, small computer systems, large computer systems, distributed cloud computing environments that include any one of the systems, and so on.

The electronic devices such as terminal devices, computer systems, and servers may be described in the general context of computer system executable instructions (for example, program modules) executed by the computer systems. Generally, the program modules may include routines, programs, target programs, assemblies, logics, data structures, and so on, which execute specific tasks or implement specific abstract data types. The computer systems/servers may be practiced in the distributed cloud computing environments in which tasks are executed by remote processing devices that are linked through a communications network. In the distributed cloud computing environments, the program modules may be located in local or remote computing system storage media including storage devices.

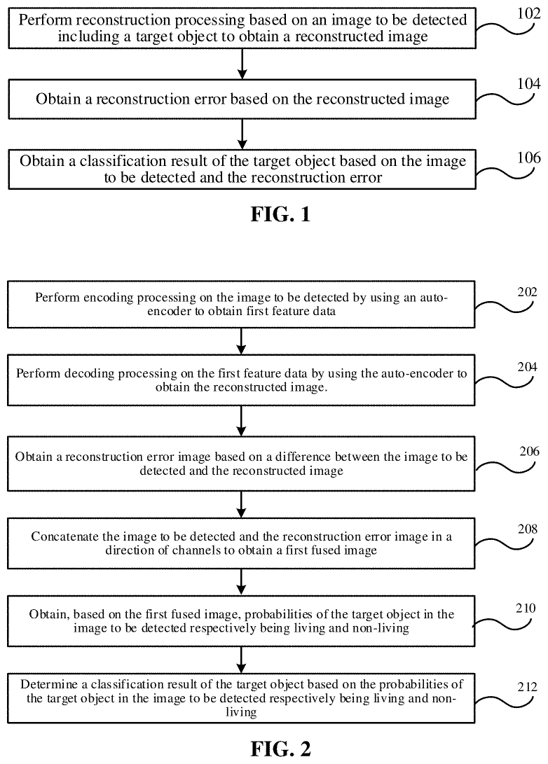

FIG. 1 is a flowchart of a method for liveness detection according to the embodiments of the present disclosure. In some embodiments, the method for liveness detection of the embodiments of the present disclosure may be implemented via a neural network (hereinafter referred to as a discriminative network). As shown in FIG. 1, the method for liveness detection includes the following operations.

At 102, reconstruction processing is performed based on an image to be detected including a target object to obtain a reconstructed image.

In the embodiments of the present disclosure, the reconstructed image may also be represented in a vector form, and in addition, the reconstructed image may also be represented in other forms, and so on. No limitation is made thereto in the embodiments of the present disclosure.

At 104, a reconstruction error is obtained based on the reconstructed image.

In some embodiments of the present disclosure, the reconstruction error may be represented as an image, and in this case, the reconstruction error is called a reconstruction error image; or the reconstructed error may be represented in a vector form, and in addition, the reconstructed error may be represented in other forms, and so on. No limitation is made thereto in the embodiments of the present disclosure.

At 106, a classification result of the target object is obtained based on the image to be detected and the reconstruction error, where the classification result is living or non-living.

The method for liveness detection of the embodiments of the present disclosure may be used for performing liveness detection on a face. In this case, the target object is a face, a living target object indicates a real face (referred to as a real person), and a non-living target object indicates a fake face (referred to as a fake person).

Based on the method for liveness detection provided by the embodiments of the present disclosure, reconstruction processing may be performed via an auto-encoder based on the image to be detected including the target object to obtain the reconstructed image, and then the classification result of the target object being living or non-living is obtained based on the image to be detected and the reconstruction error, thereby effectively distinguishing whether the target object in the image to be detected is living or non-living, effectively defending against unknown types of spoofing attacks, and improving anti-spoofing performance.

In some possible implementations, in the operation 102, reconstruction processing may be performed via an auto-encoder based on the image to be detected including the target object to obtain the reconstructed image. The auto-encoder is obtained by training based on a sample image including a living target object.

In the embodiments of the present disclosure, the auto-encoder may be obtained in advance by training based on the sample image including the living target object, reconstruction processing may be performed via the auto-encoder based on the image to be detected including the target object to obtain the reconstructed image, the reconstruction error is obtained based on the reconstructed image, and then the classification result that the target object is living or non-living is obtained based on the image to be detected and the reconstruction error, thereby effectively distinguishing whether the target object in the image to be detected is living or non-living, effectively defending against unknown types of spoofing attacks, and improving anti-spoofing performance.

The auto-encoder may be implemented based on an Encoder-Decoder model, and includes an encoding unit and a decoding unit, which are referred to as a first encoding unit and a first decoding unit in the embodiments of the present disclosure.

In some optional examples, in the operation 102, the image to be detected is input to the auto-encoder for reconstruction processing to obtain the reconstructed image.

For example, encoding processing may be performed on the image to be detected by using the auto-encoder to obtain first feature data; and decoding processing is performed on the first feature data by using the auto-encoder to obtain the reconstructed image. The feature data in the embodiments of the present disclosure may be a feature vector or a feature map, etc., and the embodiments of the present disclosure are not limited thereto.

In some possible implementations, in the operation 104, the reconstruction error may be obtained based on a difference between the reconstructed image and the image to be detected.

In some possible implementations, in the operation 106, the image to be detected and the reconstruction error may be concatenated, for example, the image to be detected and the reconstruction error are concatenated in a direction of channels to obtain first concatenation information; and the classification result of the target object is obtained based on the first concatenation information.

For example, probabilities of the target object respectively being living and non-living may be obtained based on the first concatenation information; and the classification result of the target object is determined based on the probabilities of the target object respectively being living and non-living.

FIG. 2 is another flowchart of the method for liveness detection according to the embodiments of the present disclosure. The case that the reconstruction error is a reconstruction error image is taken as an example for description. As shown in FIG. 2, the method for liveness detection includes the following operations.

At 202, encoding processing is performed on the image to be detected by using the auto-encoder to obtain the first feature data.

The auto-encoder is obtained by training based on the sample image including the living target object.

At 204, decoding processing is performed on the first feature data by using the auto-encoder to obtain the reconstructed image.

At 206, the reconstruction error image is obtained based on the difference between the image to be detected and the reconstructed image of the image to be detected.

At 208, the image to be detected and the reconstruction error image are concatenated in the direction of channels to obtain a first fused image (i.e., the first concatenation information).

At 210, the probabilities of the target object in the image to be detected respectively being living and non-living are obtained based on the first fused image.

In some embodiments, the implementation of obtaining, based on the first fused image, the probabilities of the target object in the image to be detected respectively being living and non-living may be: inputting the first fused image to a discriminative network obtained by training, to obtain the probabilities of the target object in the image to be detected respectively being living and non-living. The manner for obtaining the discriminative network by training would be described subsequently in details, and no description is made here.

At 212, the classification result of the target object is determined based on the probabilities of the target object in the image to be detected respectively being living and non-living, where the classification result is living or non-living.

Optionally, if the probability of the target object in the image to be detected being living is greater than the probability of the target object being non-living, the target object is determined to be living; and if the probability of the target object being living is not greater than the probability of the target object being non-living, the target object is determined to be non-living.

In addition, in some other possible implementations, in the operation 102, feature extraction may be performed on the image to be detected including the target object to obtain second feature data; and the second feature data is input to the auto-encoder for reconstruction processing to obtain the reconstructed image. For example, encoding processing may be performed on the second feature data by using the auto-encoder to obtain third feature data; and decoding processing is performed on the third feature data by using the auto-encoder to obtain the reconstructed image. The feature data in the embodiments of the present disclosure may be a feature vector or a feature map, etc., but the embodiments of the present disclosure are not limited thereto.

In some possible implementations, in the operation 104, the reconstruction error may be obtained based on a difference between the second feature data and the reconstructed image.

In some possible implementations, in the operation 106, the second feature data and the reconstruction error may be concatenated, for example, the second feature data and the reconstruction error are concatenated in the direction of channels to obtain second concatenation information; and the classification result of the target object is obtained based on the second concatenation information. For example, the probabilities of the target object respectively being living and non-living are obtained based on the second concatenation information; and the classification result of the target object is determined based on the probabilities of the target object respectively being living and non-living.

FIG. 3 is another flowchart of the method for liveness detection according to the embodiments of the present disclosure. The case that the feature data is a feature map and the reconstruction error is a reconstruction error image is taken as an example for description. As shown in FIG. 3, the method for liveness detection includes the following operations.

At 302, feature extraction is performed on the image to be detected including the target object to obtain a second feature map.

At 304, encoding processing is performed on the second feature map by using the auto-encoder to obtain a third feature map.

The auto-encoder is obtained by training based on the sample image including the living target object.

At 306, decoding processing is performed on the third feature map by using the auto-encoder to obtain the reconstructed image.

At 308, the reconstruction error image is obtained based on the difference between the second feature map and the reconstructed image.

At 310, the second feature map and the reconstruction error image are concatenated in the direction of channels to obtain a second fused image (i.e., the second concatenation information).

For example, the second feature map is a three-dimensional matrix of (H×W×M), the reconstruction error image is a three-dimensional matrix of (H×W×N), and the second fused image is a three-dimensional matrix of (H×W×(M+N)), where H, W, M, and N are all integers greater than 0, H indicates the length of the second feature map and of the reconstruction error image, W indicates the width of the second feature map and of the reconstruction error image, M indicates the number of channels of the second feature map, and N indicates the number of channels of the reconstruction error image.

At 312, the probabilities of the target object in the image to be detected respectively being living and non-living are obtained based on the second fused image.

In some embodiments, the implementation of obtaining, based on the second fused image, the probabilities of the target object in the image to be detected respectively being living and non-living may be: inputting the second fused image to a discriminative network obtained by training, to obtain the probabilities of the target object in the image to be detected respectively being living and non-living.

At 314, the classification result of the target object is determined based on the probabilities of the target object in the image to be detected respectively being living and non-living, where the classification result is living or non-living.

In the process of implementing the present disclosure, the present inventor finds out through investigation and research that, for a general face anti-spoofing detection problem, a positive sample is obtained by actually photographing a real person, and a negative sample is obtained by performing photographing via a spoofing tool voluntarily designed according to a known spoofing manner, and the negative sample includes a spoofing clue; however, in practical applications, such a manner for sample acquisition causes a serious problem, i.e., being unable to deal with unknown spoofing attacks. An unknown spoofing attack refers to a spoofing attack manner that is not included in an acquired training set of spoofing samples. Most of the current face anti-spoofing detection algorithms generalize face anti-spoofing as a binary classification problem, and the purpose of improving precision is achieved by continuously expanding a training data set to cover spoofing examples as many as possible. However, this manner cannot deal with unknown sample attacks and is also prone to have vulnerabilities under general spoofing sample attacks.

In the embodiments of the present disclosure, the auto-encoder is obtained by training based on a sample image including a living target object. When the present disclosure is used for performing liveness detection on a face, as the auto-encoder is obtained by training based on a sample image including a real person, and the sample image including a real person does not include any spoofing clues, the reconstructed image reconstructed via the auto-encoder for liveness detection does not include any spoofing clues. In this case, the difference obtained based on a real-person image and the reconstructed image does not represent any spoofing clue, but the difference obtained based on a fake-person image and the reconstructed image represents a spoofing clue. Based on the image to be detected and the difference, the authenticity of a face may be distinguished, thereby effectively defending against unknown spoofing faces, and the value of the reconstruction error can be used for distinguishing various samples, including known or unknown samples.

The difference between a face image and a reconstructed image thereof may also be called face prior information, which probably includes, for example, a key of a screen in a remade image, paper edges in a printed photo image, screen moiré patterns, and so on. The face prior information reflects a classification boundary between a real face and a fake face, so that the real face can be more effectively distinguished from the fake face.

The method for liveness detection in some embodiments of the present disclosure may be implemented via a neural network (hereinafter referred to as a discriminative network), where the discriminative network includes the auto-encoder.

Optionally, in the embodiments of the present disclosure, a method for obtaining the discriminative network by training is further included, i.e., a method for obtaining a discriminative network by training. For example, in one implementation, a Generative Adversarial Network (GAN) may be trained via a training set, and the discriminative network is obtained from the trained generative adversarial network, where the generative adversarial network includes a generative network and the discriminative network, and the training set includes a sample image including a living target object and a sample image including a spoofing (i.e., non-living) target object. In some possible implementations, the training set comprises at least one living real image and at least one non-living real image.

In some possible implementations, training the generative adversarial network via the training set includes: performing discrimination processing on an input image of the discriminative network via the discriminative network to obtain a classification prediction result of the input image, where the input image of the discriminative network includes a sample image in the training set or a generative image obtained via the generative network based on the sample image, annotation information of the sample image indicates that the sample image is a living real image or a non-living real image, and annotation information of the generative image indicates that the generative image is a generated image; and adjusting a network parameter of the generative adversarial network based on the classification prediction result of the input image and the annotation information of the input image.

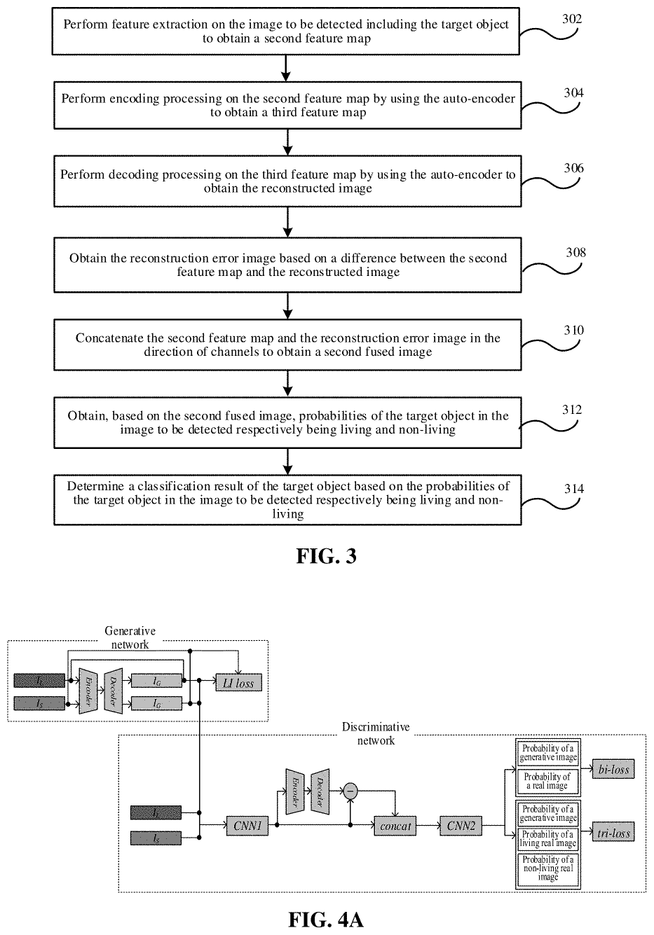

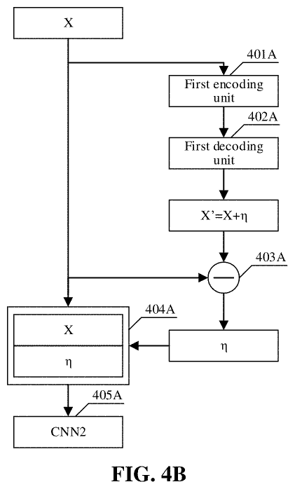

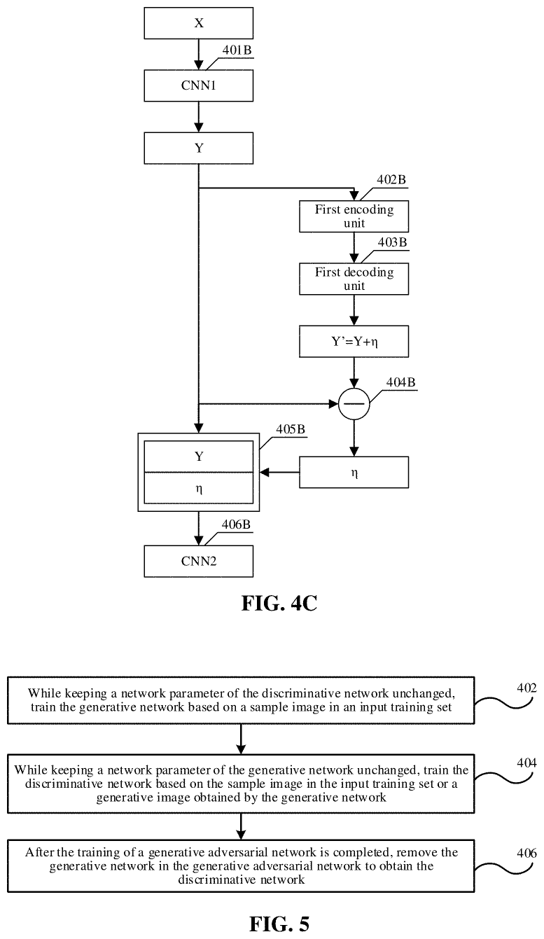

FIG. 4A is a schematic structural diagram of a generative adversarial network in the embodiments of the present disclosure. The discriminative network includes a discriminator and an auto-encoder, and the discriminator includes a convolutional neural network, a subtractor, and a concatenating unit. The convolutional neural network includes a first sub-neural network and a second sub-neural network, or may include only the second sub-neural network. If the convolutional neural network includes the first sub-neural network and the second sub-neural network, when the discriminative network obtained by training is used for liveness detection, the flow shown in FIG. 3 may be executed, and the discriminative network obtained by training may be called a discriminative network based on features of a living target object. If in the first sub-neural network and the second sub-neural network, the convolutional neural network includes only the second sub-neural network, when the discriminative network obtained by training is used for liveness detection, the flow shown in FIG. 2 may be executed, and the discriminative network obtained by training may be called a discriminative network based on a living target object. The discriminative network in FIG. 4A may perform discrimination processing on the input image of the discriminative network to obtain the classification result of the input image. The following describes a flow of a method for the discriminative network in FIG. 4A to perform the discrimination processing.

FIG. 4B is a flowchart of a method for discrimination processing provided by the embodiments of the present disclosure. As shown in FIG. 4B, the method may include the following operations.

At 401A, a first encoding unit (Encoder) performs encoding processing on an input image X to obtain a first feature map.

The first encoding unit may be the Encoder in the discriminative network in FIG. 4A.

At 402A, a first decoding unit (Decoder) performs decoding processing on the first feature map to obtain a reconstructed image of the sample image (i.e., X′ in FIG. 4B).

The first decoding unit may be the Decoder in the discriminative network in FIG. 4A.

At 403A, a subtractor (−) obtains a difference between the input image X and the reconstructed image X′ to obtain a reconstruction error image (η=X′−X).

At 404A, a concatenating unit (concat) concatenates a second feature map and the reconstruction error image in a direction of channels to obtain a second fused image, and input the second fused image to the second sub-neural network (CNN2).

If the sample image has three channels, the corresponding second feature map and reconstruction error image also have three channels, and the second fused image obtained by the concatenation has six channels.

At 405A, the CNN2 performs classification based on the second fused image to obtain the probabilities of the sample image respectively being living, non-living, and generative, and to determine a classification result of the sample image based on the probabilities of the sample image respectively being living, non-living, and generative.

Optionally, the CNN2 performs classification on the second fused image by a Softmax function to obtain the probabilities of the sample image respectively being living, non-living, and generative.

FIG. 4C is a flowchart of a method for discrimination processing provided by the embodiments of the present disclosure. As shown in FIG. 4C, the method may include the following operations.

At 401B, a first sub-neural network (CNN 1) performs feature extraction on the input image X to obtain a second feature map Y.

The CNN1 may be the CNN1 in FIG. 4A.

At 402B, the first encoding unit (Encoder) performs feature extraction on the second feature map to obtain a third feature map.

The first encoding unit may be the Encoder in the discriminative network in FIG. 4A.

At 403B, the first decoding unit (Decoder) obtains a reconstructed image Y′ of the sample image based on the third feature map.

The first decoding unit may be the Decoder in the discriminative network in FIG. 4A.

At 404B, the subtractor (−) obtains a difference between the second feature map and the reconstructed image of the sample image to obtain a reconstruction error image (η=Y′−Y).

At 405B, the concatenating unit (concat) concatenates the second feature map and the reconstruction error image in the direction of channels to obtain the second fused image and input same to the second sub-neural network (CNN2).

At 406B, the CNN2 performs classification based on the second fused image to obtain the probabilities of the sample image respectively being living, non-living, and generative, and to determine a classification result of the sample image based on the probabilities of the sample image respectively being living, non-living, and generative.

Optionally, the CNN2 performs classification on the second fused image by a Softmax function to obtain the probabilities of the sample image respectively being living, non-living, and generative.

It should be understood that the flow of the method in FIG. 4C may be a discrimination flow executed via the discriminative network in FIG. 4A, and the flow of the method in FIG. 4B may be a discrimination flow executed via a part of the discriminative network in FIG. 4A except the CNN1.

In some embodiments of the present disclosure, the auto-encoder may use an encoder-decoder model, where the auto-encoder may be trained in the process of training the discriminative network. The auto-encoder may also be trained first, and the discriminative network is trained while keeping network parameters of the trained auto-encoder unchanged. No limitation is made thereto in the embodiments of the present disclosure.

In addition, before the method for training a discriminative network in the foregoing embodiments, the encoder-decoder model may be trained first based on a sample image of a living target object to obtain an auto-encoder.

For example, in some possible implementations, the first encoding unit in the encoder-decoder model may be used for performing encoding processing on the sample image including the living target object to obtain encoded data; the first decoding unit in the encoder-decoder model is used for performing decoding processing on the encoded data to obtain the reconstructed image; and the encoder-decoder model is trained based on the difference between the sample image including the living target object and the reconstructed image to obtain the auto-encoder.

FIG. 5 is a flowchart of a method for training a discriminative network according to the embodiments of the present disclosure. As shown in FIG. 5, the method for training a discriminative network includes the following operations.

At 402, while keeping a network parameter of the discriminative network being unchanged, the generative network is trained based on a sample image in an input training set.

At 404, while keeping a network parameter of the generative network being unchanged, the discriminative network is trained based on a sample image in the input training set or a generative image obtained via the generative network.

The operations 402-404 may be executed iteratively for multiple times, until a preset training completion condition is satisfied. If the training of the discriminative network is completed, then the training of the GAN is completed.

At 406, after the training of the generative adversarial network is completed, the generative network in the generative adversarial network is removed to obtain the discriminative network.

Based on the method for training a discriminative network provided by the embodiments of the present disclosure, the generative adversarial network including the generative network and the discriminative network is trained via the training set. After the training is completed, the generative network in the generative adversarial network is removed, obtain the discriminative network for performing the method for liveness detection. By using a generative and adversarial mode of the generative adversarial network, the diversity of samples may be improved, the defense capability of the discriminative network against the unknown types of spoofing attacks may be improved, and the precision of defense against known spoofing attacks may be improved.

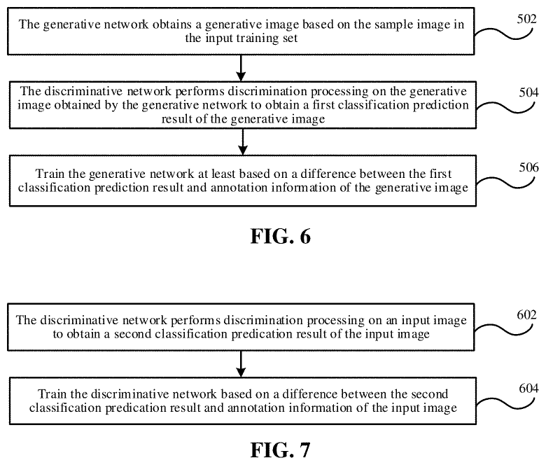

FIG. 6 is a flowchart of training a generative network in the embodiments of the present disclosure. The annotation information of the generative image is set as generative. As shown in FIG. 6, in some possible implementations, in the operation 402, training the generative network based on the sample image in the input training set includes the following operations.

At 502, the generative network obtains a generative image based on the sample image in the input training set.

At 504, the discriminative network performs discrimination processing on the generative image obtained via the generative network to obtain a classification result of the generative image, i.e., a first classification prediction result.

The first classification prediction result includes living or non-living.

For example, the discriminative network may take the received image as the image to be detected in the foregoing embodiments, and obtain the classification result of the target object in the received image by the flows of the foregoing embodiments.

At 506, the generative network is trained at least based on a difference between the first classification prediction result and the annotation information of the generative image, i.e., adjusting the network parameter of the generative network.

When the generative network is being trained, the network parameter of the discriminative network is fixed, and the network parameter of the generative network is adjusted.

The operations 502-506 may be iteratively executed to train the generative network until a present condition, for example, the number of trainings of the generative network reaching a preset number, and/or the difference between the first classification prediction result and the annotation information (corresponding to the bi-loss in FIG. 4A) being less than a first preset value, is satisfied, such that the generative image obtained via the generative network is forced to be closer to a sample image of a real non-living target object. Based on the embodiments of the present disclosure, various sample images that are closer to the real non-living target object may be generated via the generative network, thereby expanding the data distribution of spoofing samples and improving the diversity of spoofing samples.

In some possible implementations, obtaining the generative image via the generative network based on the sample image in the input training set includes the following operations.

The generative network obtains fourth feature data based on the sample image in the input training set.

The generative network adds a random datum to the fourth feature data to obtain fifth feature data having a preset length. The length of the fourth feature data is less than that of the fifth feature data.

The generative network obtains the generative image based on the fifth feature data.

The generative network may also use an Encoder-Decoder model architecture, and is implemented based on the Encoder-Decoder model. The generative network includes an encoding unit (referred to as the second encoding unit in the embodiments of the present disclosure), a generating unit, and a decoding unit (referred to as the second decoding unit in the embodiments of the present disclosure).

In some possible implementations, the second encoding unit in the generative network may be used for performing feature extraction and down-sampling on the sample image in the input training set to obtain fourth feature data (i.e., a feature of an original sample image) as main feature information of the generative image. The generating unit in the generative network may be used for adding a random datum to the fourth feature data to obtain fifth feature data having a preset length, and incorporates the main feature information of the original sample image to the fifth feature data. The fourth feature data and the fifth feature data may be represented as feature maps, and may also be represented as feature vectors. For example, when the fourth feature data and the fifth feature data may be represented as feature vectors, the second encoding unit may perform feature extraction and down-sampling on the sample image in the input training set to obtain a relatively short feature vector (i.e., the fourth feature data), and the generating unit may add a random vector (i.e., the random datum) to the relatively short (i.e., less than the preset length) feature vector to obtain fifth feature vector having a preset length (i.e., the fifth feature data). Then, the second decoding unit in the generative network may be used for obtaining the generative image based on the fifth feature data.

For example, in FIG. 4A, a sample image is input to the generative network. The sample image may be a sample image (I_{L}) of a living target object, and may also be a sample image (I_{S}) of a non-living target object; when the generative network obtains the generative image based on the input sample image, the second encoding unit (Encoder) is used for performing feature extraction on the input sample image and performing downsampling on the extracted feature to obtain a fourth feature vector having a length less than the preset length; the generating unit (not shown, and located between the Encoder and the Decoder) is used for adding a random vector to the fourth feature vector to obtain a fifth feature vector having a preset length; and then the second decoding unit (Decoder) is used for obtaining a generative image (IG) based on the fifth feature vector.

In some possible implementations, in the operation 506, the generative network may be trained based on the difference between the first classification prediction result and the annotation information of the generative image and the difference between the generative image and the received sample image.

For example, in FIG. 4A, the difference between the first classification prediction result and the annotation information of the generative image is denoted as bi-loss, the difference between the generative image and the received sample image is denoted as L_{G}, and in the process of training the generative network, the quality of the generative image may be constrained by L_{G}, where L_{G} may be represented as follows:

$${L}_{G} = {{\sum }_{i = 1}}^{n} \vert {x}^{i} - G ( {x}^{i} ) \vert . \qquad Formula ( 1 )$$

In formula (1), L_{G} is an image quality loss function between the generative image and the received sample image, x indicates the input image of the generative network, G(x) indicates the generative image of the generative network (i.e., I_{G}), and i indicates pixel points, i.e., the sum of the difference values between pixel points in the generative image and in the received sample image is used as the image quality loss function between the generative image and the received sample image.

In the embodiments of training the generative network, the bi-loss and L_{G} may be reversely transmitted together to update the network parameters of the Encoder-Decoder in the generative network to train the generative network.

In the embodiments of the present disclosure, the generative network is trained by both the difference between the first classification prediction result and the annotation information of the generative image and the difference between the generative image and the received sample image, so that the quality of the generative image obtained via the generative network is closer to that of an original input image, and is closer to that of the sample image of the real non-living target object.

FIG. 7 is a flowchart of training a discriminative network in the embodiments of the present disclosure. The input image includes the sample image in the training set or the generative image obtained via the generative network based on the sample image. The annotation information of the sample image indicates a living real image or a non-living real image. The annotation information of the sample image of a living target object may be set as living, indicating the living real image; the annotation information of the sample image of a non-living target object may be set as non-living, indicating the non-living real image; and the annotation information of the generative image may be set as generative, indicating the generative image. As shown in FIG. 7, in some possible implementations, training the discriminative network based on the sample image in the input training set or the generative image obtained via the generative network includes the following operations.

At 602, the discriminative network performs discrimination processing on an input image to obtain a classification result of the input image, i.e., a second classification predication result.

The input image includes the sample image in the training set or the generative image obtained via the generative network based on the sample image, the annotation information of the sample image indicates that the sample image is a living real image or a non-living real image, and the annotation information of the generative image indicates that the generative image is a generated image. The second classification predication result includes living, non-living, and generative, which correspond to the living real image, the non-living real image, or the generative image, respectively.

For example, the discriminative network may take the input image as the image to be detected in the embodiments, and obtain the classification result of the input image by the flows of the foregoing embodiments.

At 604, the discriminative network is trained based on the difference between the second classification prediction result and the annotation information of the input image, i.e., adjusting the network parameter of the discriminative network.

When the discriminative network is being trained, the network parameter of the generative network is fixed, and the network parameter of the discriminative network is adjusted.

The operations 602-604 may be iteratively executed to train the discriminative network until a present condition is satisfied. For example, the number of trainings for the discriminative network reaches a preset number, and/or the difference between the second classification prediction result and the annotation information of the input image (corresponding to the tri-loss in FIG. 4A) is less than a second preset value.

A loss function of the discriminative network obtained after the auto-encoder is added to the discriminator (i.e., the difference between the second classification prediction result and the annotation information of the input image) may be represented as follows:

L_{R,D}(x)=(1−λ)L_{R}(x)+λL_{D}(x,x−R(x)) Formula (2).

In formula (2), R indicates an auto-encoder, D indicates a discriminator, L_{R} indicates a loss function of the auto-encoder, L_{D} indicates a loss function of the discriminator, λ is a balance parameter between the discriminator and the auto-encoder, and the value of is a constant greater than 0 and less than 1 and may be preset according to an empirical value.

Optionally, when the input image of the discriminative network is the generative image obtained via the generative network, before the operation 602, further included is that the generative network obtains the generative image based on the sample image in the input training set. For some implementations of obtaining the generative image via the generative network based on the sample image in the input training set, reference can be made to the descriptions of the foregoing embodiments of the present disclosure, and details are not described herein again.

The present disclosure introduces a generative adversarial mode for a face anti-spoofing problem. By expanding a spoofing sample set by using the generative and adversarial mode of the GAN, the diversity of samples may be increased, and a real-world spoofing attack problem is simulated. The GAN network is trained, the generative and adversarial mode is used for improving the precision of the discriminative network, and when the discriminative network obtained after training is used in an anti-spoofing system, the defense capability against unknown samples may be effectively improved, and the defense precision against known spoofing samples is improved.

For example, taking FIG. 4A as an example, in the operation 602, the first sub-neural network (CNN1) performs feature extraction on the received sample image (denoted as X) to obtain the second feature map; the first encoding unit (Encoder) in the auto-encoder performs feature extraction on the second feature map to obtain the third feature map; the first decoding unit (Decoder) in the auto-encoder obtains the reconstructed image (denoted as X′) of the sample image based on the third feature map; the subtractor (−) obtains the difference between the second feature map and the reconstructed image of the sample image to obtain the reconstruction error image (η=X′−X); the concatenating unit (concat) concatenates the second feature map and the reconstruction error image in the direction of channels to obtain the second fused image and input same to the second sub-neural network (CNN2), where if the sample image has three channels, the corresponding second feature map and reconstruction error image also have three channels, and the second fused image obtained by the concatenation has six channels; and the CNN2 performs classification based on the second fused image to obtain the probabilities of the sample image respectively being living, non-living, and generative, and to determine a classification result of the sample image based on the probabilities of the sample image respectively being living, non-living, and generative.

When the first sub-neural network (CNN1) is not included in FIG. 4A, the first encoding unit (Encoder) in the auto-encoder performs encoding processing on the input image to obtain the first feature map; the first decoding unit (Decoder) in the auto-encoder performs decoding processing on the first feature map to obtain the reconstructed image (denoted as X′) of the sample image; the subtractor (−) obtains the difference between the input image and the reconstructed image to obtain the reconstruction error image (η=X′−X); the concatenating unit (concat) concatenates the second feature map and the reconstruction error image in the direction of channels to obtain the second fused image and input same to the second sub-neural network (CNN2), where if the sample image has three channels, the corresponding second feature map and reconstruction error image also have three channels, and the second fused image obtained by the concatenation has six channels; and the CNN2 performs classification based on the second fused image to obtain the probabilities of the sample image respectively being living, non-living, and generative, and to determine a classification result of the sample image based on the probabilities of the sample image respectively being living, non-living, and generative.

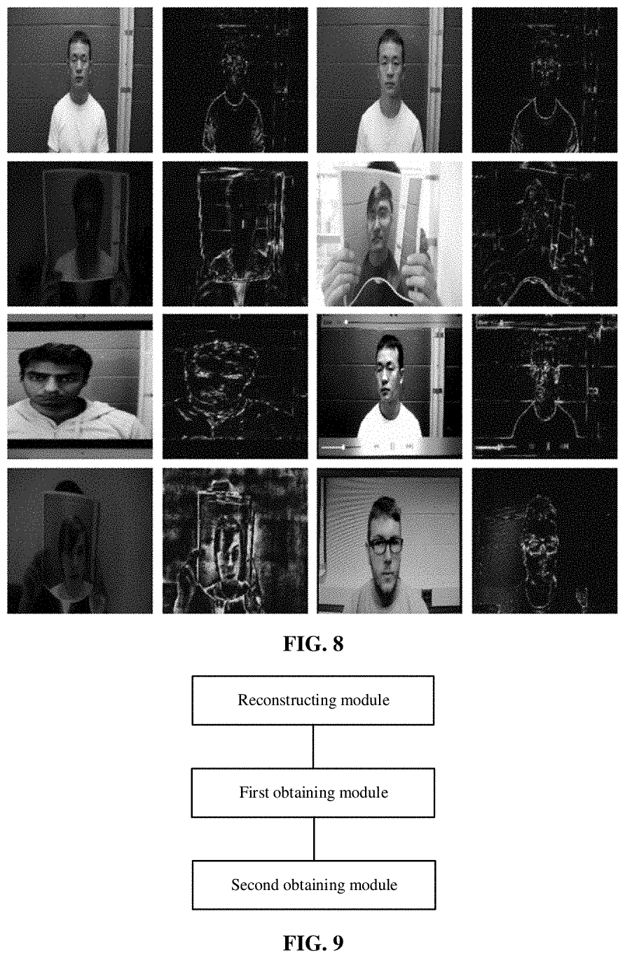

For example, in an application of the embodiment shown in FIG. 2 of the present disclosure, taking the performing of liveness detection on a face as an example, FIG. 8 is an example of original images and reconstruction error images of real persons/fake persons. In FIG. 8, the first column and the third column are original images, the second column and the fourth column are reconstruction error images of the original images, and the first row is real persons and the second to fourth rows are fake persons. It can be seen from FIG. 8 that the reconstruction error images corresponding to the original images of the fake persons are highlighted at positions with large reconstruction errors, and the reconstruction errors in the reconstruction error images corresponding to the original images of the real persons have relatively small brightness, indicating that the reconstruction errors are small. For example, in FIG. 8, the fake persons have more obvious reconstruction errors at the ears, eyes, and noses, or at the paper edges, moiré patterns, and other spoofing clues. In addition, obvious reconstruction errors are also presented in the remade images of the fake persons and the printed photo images of the fake persons. The embodiments of the present disclosure can effectively capture spoofing clue information based on the presented reconstruction errors, such as the “play” key displayed on the screen in the remade image and obvious paper edge information in the printed photo image, and the captured spoofing clue information can increase the differences between the distribution of features extracted from the real persons and the fake persons. In addition, from a visual reconstruction error image, the present disclosure can effectively improve the liveness detection performance, and can improve the defense capability against unknown spoofing samples.

Any method for liveness detection provided by the embodiments of the present disclosure may be executed via any appropriate device having a data processing capability, including, but not limited to, a terminal device, a server, and the like. Alternatively, any method for liveness detection provided by the embodiments of the present disclosure may be executed via a processor, for example, any method for liveness detection mentioned in the embodiments of the present disclosure is executed via a processor by invoking corresponding instructions stored in a memory. Details are not described below again.

A person of ordinary skill in the art may understand that all or some steps for implementing the foregoing method embodiments may be completed via a program by instructing related hardware; the foregoing program may be stored in a computer readable storage medium; when the program is executed, steps including the foregoing method embodiments are executed. Moreover, the foregoing storage medium includes various media capable of storing program codes, such as an ROM, an RAM, a magnetic disk, or an optical disk.

FIG. 9 is a schematic structural diagram of an apparatus for liveness detection according to the embodiments of the present disclosure. The apparatus for liveness detection may be used for implementing the foregoing method embodiments for liveness detection. As shown in FIG. 9, the apparatus for liveness detection includes: a reconstructing module, configured to perform reconstruction processing via an auto-encoder based on an image to be detected including a target object to obtain a reconstructed image; a first obtaining module, configured to obtain a reconstruction error based on the reconstructed image; and a second obtaining module, configured to obtain a classification result of the target object based on the image to be detected and the reconstruction error, where the classification result is living or non-living.

Based on the apparatus for liveness detection provided by the embodiments of the present disclosure, reconstruction processing is performed based on an image to be detected including a target object to obtain a reconstructed image, a reconstruction error is obtained based on the reconstructed image, and then a classification result that the target object is living or non-living is obtained based on the image to be detected and the reconstruction error, thereby effectively distinguishing whether the target object in the image to be detected is living or non-living, effectively defending against unknown types of spoofing attacks, and improving anti-spoofing performance.

In some optional implementations, the reconstructing module includes an auto-encoder, and the auto-encoder is obtained by training based on a sample image including a living target object.

In some optional implementations, the reconstructing module is configured to perform reconstruction processing on an input image to be detected to obtain a reconstructed image.

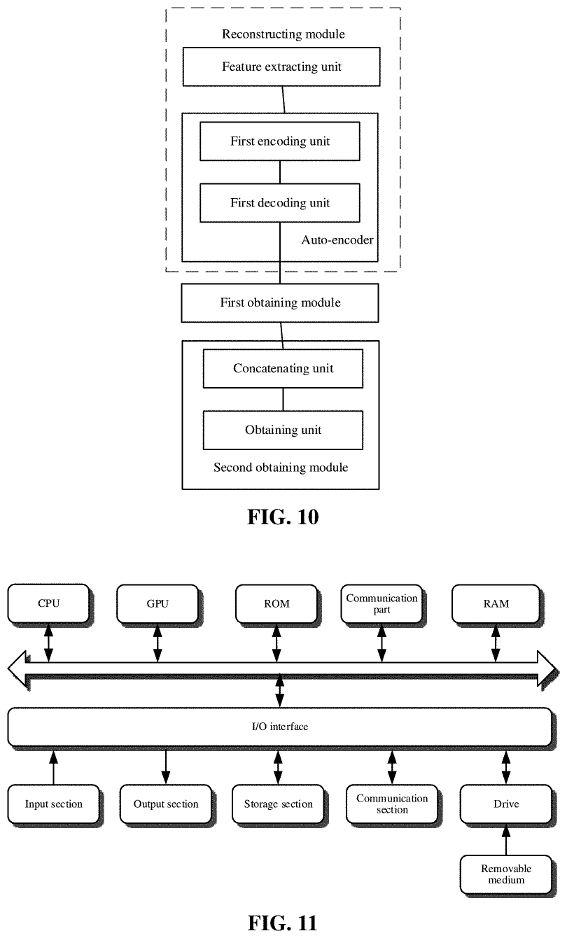

FIG. 10 is another schematic structural diagram of the apparatus for liveness detection according to the embodiments of the present disclosure. As shown in FIG. 10, compared with the embodiment shown in FIG. 9, in the apparatus for liveness detection, the auto-encoder includes: a first encoding unit, configured to perform encoding processing on the image to be detected to obtain first feature data; and a first decoding unit, configured to perform decoding processing on the first feature data to obtain the reconstructed image.

In some optional implementations, the first obtaining module is configured to obtain a reconstruction error based on a difference between the reconstructed image and the image to be detected. Accordingly, the second obtaining module includes: a concatenating unit, configured to concatenate the image to be detected and the reconstruction error to obtain first concatenation information; and an obtaining unit, configured to obtain the classification result of the target object based on the first concatenation information.

As shown in FIG. 10, in some other optional implementations, the reconstructing module includes: a feature extracting unit, configured to perform feature extraction on the image to be detected including the target object to obtain second feature data; and an auto-encoder, configured to perform reconstruction processing on the second feature data to obtain the reconstructed image.

Accordingly, in some other optional implementations, the auto-encoder includes: a first encoding unit, configured to perform encoding processing on the second feature data to obtain third feature data; and a first decoding unit, configured to perform decoding processing on the third feature data to obtain the reconstructed image.

Accordingly, in some other optional implementations, the first obtaining module is configured to obtain the reconstruction error based on a difference between the second feature data and the reconstructed image. Accordingly, the second obtaining module includes: a concatenating unit, configured to concatenate the second feature data and the reconstruction error to obtain second concatenation information; and an obtaining unit, configured to obtain the classification result of the target object based on the second concatenation information.

In addition, the apparatus for liveness detection of the embodiments of the present disclosure may be selectively implemented via a discriminative network. Accordingly, the apparatus for liveness detection of the embodiments of the present disclosure further includes: a training module, configured to train a generative adversarial network via a training set to obtain a discriminative network from the trained generative adversarial network, where the generative adversarial network includes a generative network and the discriminative network, and the training set includes a sample image including a living target object and a sample image including a non-living target object.

In some optional implementations, the discriminative network is configured to perform discrimination processing on an input image to obtain a classification prediction result of the input image, where the input image includes a sample image in the training set or a generative image obtained via the generative network based on the sample image, annotation information of the sample image indicates that the sample image is a living real image or a non-living real image, and annotation information of the generative image indicates that the generative image is a generated image; and the training module is configured to adjust a network parameter of the generative adversarial network based on the classification prediction result of the input image and the annotation information of the input image.

In addition, an electronic device provided by the embodiments of the present disclosure includes:

a memory, configured to store computer programs; and

a processor, configured to execute the computer programs stored in the memory, where when the computer programs are executed, the method for liveness detection according to any one of the foregoing embodiments of the present disclosure is implemented.

FIG. 11 is a schematic structural diagram of an application embodiment of an electronic device of the present disclosure. With reference to FIG. 11 below, a schematic structural diagram of an electronic device, such as a terminal device or a server, suitable for implementing the embodiments of the present disclosure is shown. As shown in FIG. 11, the electronic device includes one or more processors, a communication part and the like. The one or more processors are, for example, one or more Central Processing Units (CPUs), and/or one or more image processors (GPUs) or the like; the processor may execute various appropriate actions and processing according to executable instructions stored in a Read-Only Memory (ROM) or executable instructions loaded from a storage section to a Random Access Memory (RAM). The communication part may include, but is not limited to, a network card. The network card may include, but is not limited to, an IB (Infiniband) network card. The processor may communicate with the ROM and/or the RAM to execute executable instructions. The processor is connected to the communication part via a bus, and communicates with other target devices via the communication part, thereby implementing operations corresponding to any method for liveness detection provided by the embodiments of the present disclosure, for example, performing reconstruction processing based on an image to be detected including a target object to obtain a reconstructed image, obtaining a reconstruction error based on the reconstructed image, and obtaining a classification result of the target object based on the image to be detected and the reconstruction error, where the classification result is living or non-living.

In addition, the RAM may further store various programs and data required during an operation of the apparatus. The CPU, the ROM, and the RAM are connected to each other via the bus. In the presence of the RAM, the ROM is an optional module. The RAM stores executable instructions, or writes executable instructions to the ROM during running. The executable instructions cause the processor to execute the operations corresponding to any method for liveness detection according to the present disclosure. An input/output (I/O) interface is also connected to the bus. The communication part may be configured integrally, or may also be configured to have a plurality of sub-modules (for example, a plurality of IB network cards) linked on the bus.

The following components are connected to the I/O interface: an input section including a keyboard, a mouse and the like; an output section including a Cathode-Ray Tube (CRT), a Liquid Crystal Display (LCD), a speaker and the like; a storage section including a hard disk and the like; and a communication section of a network interface card such as an LAN card and a modem. The communication section executes communication processing via a network such as the Internet. A drive is also connected to the I/O interface according to requirements. A removable medium such as a magnetic disk, an optical disk, a magneto-optical disk, or a semiconductor memory is mounted on the drive according to requirements, so that computer programs read from the removable medium may be installed on the storage section according to requirements.

It should be noted that, the architecture shown in FIG. 11 is merely an optional implementation. During specific practice, the number and types of the components in FIG. 11 may be selected, decreased, increased, or replaced according to actual requirements. Different functional components may be separated or integrated or the like. For example, the GPU and the CPU may be separated, or the GPU may be integrated on the CPU, and the communication part may be separated from or integrated on the CPU or the GPU or the like. These alternative implementations all fall within the scope of protection of the present disclosure.

Particularly, the process described above with reference to the flowchart according to the embodiments of the present disclosure may be implemented as a computer software program. For example, the embodiments of the present disclosure include a computer program product. The computer program product includes computer programs tangibly included in a machine-readable medium. The computer program includes program codes for executing the method shown in the flowchart. The program codes may include corresponding instructions for correspondingly executing the steps of the method for liveness detection provided by the embodiments of the present disclosure. In such embodiments, the computer program may be downloaded and installed from the network through a communication section, and/or is installed from the removable medium. When executed by the CPU, the computer program executes the functions defined in the method of the present disclosure.

In addition, the embodiments of the present disclosure further provide computer programs, including computer instructions. When the computer instructions are run in a processor of a device, the method for liveness detection according to any one of the foregoing embodiments of the present disclosure is implemented.

In addition, the embodiments of the present disclosure further provide a computer readable storage medium having computer programs stored thereon. When the computer programs are executed via a processor, the method for liveness detection according to any one of the foregoing embodiments of the present disclosure is implemented.

Various embodiments in the present specification are all described in a progressive manner, for same or similar parts in the embodiments, refer to these embodiments, and each embodiment focuses on a difference from other embodiments. The system embodiments correspond to the method embodiments substantially and therefore are only described briefly, and for the associated part, refer to the descriptions of the method embodiments.

The method and the apparatus of the present disclosure may be implemented in many manners. For example, the method and apparatus of the present disclosure may be implemented by using software, hardware, firmware, or any combination of software, hardware, and firmware. Unless otherwise specially stated, the foregoing sequences of steps of the method are merely for description, and are not intended to limit the steps of the method of the present disclosure. In addition, in some embodiments, the present disclosure may be implemented as programs recorded in a recording medium. The programs include machine readable instructions for implementing the method according to the present disclosure. Therefore, the present disclosure further covers the recording medium storing the programs for executing the method according to the present disclosure.

The descriptions of the present disclosure are provided for the purpose of examples and description, and are not intended to be exhaustive or limit the present disclosure to the disclosed form. Many modifications and changes are obvious to a person of ordinary skill in the art. The embodiments are selected and described to better describe a principle and an actual application of the present disclosure, and to make a person of ordinary skill in the art understand the present disclosure, so as to design various embodiments with various modifications applicable to particular use.

1. A method for liveness detection, comprising:
performing reconstruction processing based on an image to be detected comprising a target object to obtain a reconstructed image;
obtaining a reconstruction error based on the reconstructed image; and
obtaining a classification result of the target object based on the image to be detected and the reconstruction error, wherein the classification result is living or non-living.

2. The method according to claim 1, wherein performing reconstruction processing based on the image to be detected comprising the target object to obtain the reconstructed image comprises:
performing reconstruction processing via an auto-encoder based on the image to be detected comprising the target object to obtain the reconstructed image.

3. The method according to claim 1, wherein performing reconstruction processing based on the image to be detected comprising the target object to obtain the reconstructed image comprises:
inputting the image to be detected to an auto-encoder for reconstruction processing to obtain the reconstructed image.

4. The method according to claim 3, wherein inputting the image to be detected to the auto-encoder for reconstruction processing to obtain the reconstructed image comprises:
performing encoding processing on the image to be detected by using the auto-encoder to obtain first feature data; and
performing decoding processing on the first feature data by using the auto-encoder to obtain the reconstructed image.

5. The method according to claim 3, wherein obtaining the reconstruction error based on the reconstructed image comprises:
obtaining the reconstruction error based on a difference between the reconstructed image and the image to be detected; and
wherein obtaining the classification result of the target object based on the image to be detected and the reconstruction error comprises:
concatenating the image to be detected and the reconstruction error to obtain first concatenation information; and
obtaining the classification result of the target object based on the first concatenation information.

6. The method according to claim 1, wherein performing reconstruction processing based on the image to be detected comprising the target object to obtain the reconstructed image comprises:
performing feature extraction on the image to be detected comprising the target object to obtain second feature data; and
inputting the second feature data to an auto-encoder for reconstruction processing to obtain the reconstructed image.

7. The method according to claim 6, wherein inputting the second feature data to the auto-encoder for reconstruction processing to obtain the reconstructed image comprises:
performing encoding processing on the second feature data by using the auto-encoder to obtain third feature data; and
performing decoding processing on the third feature data by using the auto-encoder to obtain the reconstructed image.

8. The method according to claim 6, wherein obtaining the reconstruction error based on the reconstructed image comprises:
obtaining the reconstruction error based on a difference between the second feature data and the reconstructed image; and
wherein obtaining the classification result of the target object based on the image to be detected and the reconstruction error comprises:
concatenating the second feature data and the reconstruction error to obtain second concatenation information; and
obtaining the classification result of the target object based on the second concatenation information.

9. The method according to claim 1, wherein the method for liveness detection is implemented via a discriminative network; and
the method further comprises:
training a generative adversarial network via a training set to obtain the discriminative network, wherein the generative adversarial network comprises a generative network and the discriminative network.

10. The method according to claim 9, wherein the training set comprises at least one living real image and at least one non-living real image.

11. An electronic device, comprising:
a memory, configured to store computer programs; and
a processor, configured to execute the computer programs stored in the memory, wherein when the computer programs are executed, the processor is configured to perform a method comprising the following operations:
performing reconstruction processing based on an image to be detected comprising a target object to obtain a reconstructed image;
obtaining a reconstruction error based on the reconstructed image; and
obtaining a classification result of the target object based on the image to be detected and the reconstruction error, wherein the classification result is living or non-living.

12. The electronic device according to claim 11, wherein performing reconstruction processing based on the image to be detected comprising the target object to obtain the reconstructed image, comprises:
inputting the image to be detected to an auto-encoder for reconstruction processing to obtain the reconstructed image.

13. The electronic device according to claim 11, wherein performing reconstruction processing based on the image to be detected comprising the target object to obtain the reconstructed image comprises:
performing reconstruction processing via an auto-encoder based on the image to be detected comprising the target object to obtain the reconstructed image.

14. The electronic device according to claim 12, wherein inputting the image to be detected to the auto-encoder for reconstruction processing to obtain the reconstructed image comprises:
performing encoding processing on the image to be detected by using the auto-encoder to obtain first feature data; and
performing decoding processing on the first feature data by using the auto-encoder to obtain the reconstructed image.

15. The electronic device according to claim 12, wherein obtaining the reconstruction error based on the reconstructed image comprises:
obtaining the reconstruction error based on a difference between the reconstructed image and the image to be detected; and
wherein obtaining the classification result of the target object based on the image to be detected and the reconstruction error comprises:
concatenating the image to be detected and the reconstruction error to obtain first concatenation information; and
obtaining the classification result of the target object based on the first concatenation information.

16. The electronic device according to claim 11, wherein performing reconstruction processing based on the image to be detected comprising the target object to obtain the reconstructed image comprises:
performing feature extraction on the image to be detected comprising the target object to obtain second feature data; and
inputting the second feature data to an auto-encoder for reconstruction processing to obtain the reconstructed image.

17. The electronic device according to claim 16, wherein inputting the second feature data to the auto-encoder for reconstruction processing to obtain the reconstructed image comprises:
performing encoding processing on the second feature data by using the auto-encoder to obtain third feature data; and
performing decoding processing on the third feature data by using the auto-encoder to obtain the reconstructed image.

18. The electronic device according to claim 16, wherein obtaining the reconstruction error based on the reconstructed image:
obtaining the reconstruction error based on a difference between the second feature data and the reconstructed image; and
wherein obtaining the classification result of the target object based on the image to be detected and the reconstruction error comprises:
concatenating the second feature data and the reconstruction error to obtain second concatenation information; and
obtaining the classification result of the target object based on the second concatenation information.

19. The electronic device according to claim 11, wherein the electronic device comprises a discriminative network model for implementing the method; and
the discriminative network model is obtained by training a generative adversarial network model by a training set, the generative adversarial network model comprising a generative network and the discriminative network.

20. A non-transitory computer readable storage medium having computer programs stored thereon, wherein when the computer programs are executed via a processor, the following operations are performed:
performing reconstruction processing based on an image to be detected comprising a target object to obtain a reconstructed image;
obtaining a reconstruction error based on the reconstructed image; and
obtaining a classification result of the target object based on the image to be detected and the reconstruction error, wherein the classification result is living or non-living.
